(19) United States
(12) Patent Application Publication
(10) Pub. No.: US 2022/0386371 A1
(43) Pub. Date: Dec. 1, 2022

(54) DATA TRANSMISSION METHOD AND APPARATUS FOR UNLICENSED BAND, AND COMMUNICATION DEVICE

(71) Applicant: VIVO MOBILE COMMUNICATION CO., LTD., Dongguan (CN)

(72) Inventor: Lei JIANG, Dongguan (CN)

(73) Assignee: VIVO MOBILE COMMUNICATION CO., LTD., Dongguan (CN)

(21) Appl. No.: 17/880,571

(22) Filed: Aug. 3, 2022

Related U.S. Application Data
(63) Continuation of application No. PCT/CN2021/074343, filed on Jan. 29, 2021.

(30) Foreign Application Priority Data
Feb. 5, 2020 (CN) 202010080691.6

(51) Int. Cl. H04W 74/08; H04W 16/14

(52) U.S. Cl. CPC H04W 74/0808; H04W 16/14; H04W 74/0833

(57) ABSTRACT

A data transmission method and apparatus for an unlicensed band, and a communication device are provided. The data transmission method, performed by a terminal, includes: performing uplink transmission based on Fixed Frame Period (FFP) configuration information and a channel state. The FFP configuration information includes at least one of an FFP start location or an FFP length of the terminal, and at least one of an FFP start location or an FFP length of a network-side device. The FFP start location of the terminal is different from the FFP start location of the network-side device.

### CROSS-REFERENCE TO RELATED APPLICATIONS

This application is a continuation of International Application No. PCT/CN2021/074343, filed on Jan. 29, 2021, which claims priority to Chinese Patent Application No. 202010080691.6 filed on Feb. 5, 2020. The entire contents of each of the above-referenced applications are expressly incorporated herein by reference.

### TECHNICAL FIELD

The present disclosure relates to the field of communications technologies, and in particular, to a data transmission method and apparatus for an unlicensed band, and a communication device.

### BACKGROUND

In a future communications system, an unlicensed band can be used as a supplement to a licensed band to help an operator expand a service. During use, the unlicensed band must comply with a regulation, to ensure that all devices can use the resource fairly, for example, a regulation such as Listen Before Talk (LBT) or Maximum Channel Occupancy Time (MCOT). When a transmission node needs to perform LBT first before sending information, Energy Detection (ED) is performed on a surrounding node. When detected power is less than a threshold, it is considered that a channel is idle, and the transmission node can send the information. Otherwise, it is considered that the channel is busy, and the transmission node cannot send the information.

Frame Based Equipment (FBE) means that a periodic structure is used for sending and/or receiving timing of a device, and a period of the FBE is a Fixed Frame Period (FFP). An FBE node uses an LBT-based channel access mechanism to occupy a channel In an FBE mechanism, according to the prior art, downlink signal detection needs to be performed for any uplink transmission, and User Equipment (UE) can perform transmission only after detecting a downlink signal, regardless of uplink transmission with dynamic grant or uplink transmission with configured grant. For transmission with configured grant, if a gNB end cannot occupy a channel, the UE cannot perform transmission with configured grant even if a channel at a UE end is idle. This reduces efficiency of transmission with configured grant. In addition, for initial access or transmission with configured grant, the gNB does not know when the UE accesses or when data needs to be transmitted. To ensure access or transmission of the UE as much as possible, the gNB needs to frequently perform listening to preempt a channel, and send a downlink signal and/or a channel, thereby bringing unnecessary sending of redundant signals.

### SUMMARY

Embodiments of the present disclosure provide a data transmission method and apparatus for an unlicensed band, and a communication device, so that in an FBE access mechanism of the unlicensed band, a gNB and UE can flexibly share a transmission channel

According to a first aspect, an embodiment of the present disclosure provides a data transmission method for an unlicensed band, applied to a terminal and including:

performing uplink transmission based on fixed frame period FFP configuration information and a channel state, where the FFP configuration information includes at least one of an FFP start location and an FFP length of the terminal and at least one of an FFP start location and an FFP length of a network-side device, and the FFP start location of the terminal is different from the FFP start location of the network-side device.

According to a second aspect, an embodiment of the present disclosure further provides a data transmission method for an unlicensed band, applied to a network-side device and including:

performing downlink transmission based on fixed frame period FFP configuration information and a channel state, where the FFP configuration information includes at least one of an FFP start location and an FFP length of the network-side device and at least one of an FFP start location and an FFP length of a terminal, and the FFP start location of the network-side device is different from the FFP start location of the terminal.

According to a third aspect, an embodiment of the present disclosure provides a data transmission apparatus for an unlicensed band, applied to a terminal and including:

a first transmission module, configured to perform uplink transmission based on fixed frame period FFP configuration information and a channel state, where the FFP configuration information includes at least one of an FFP start location and an FFP length of the terminal and at least one of an FFP start location and an FFP length of a network-side device, and the FFP start location of the terminal is different from the FFP start location of the network-side device.

According to a fourth aspect, an embodiment of the present disclosure further provides a data transmission apparatus for an unlicensed band, applied to a network-side device and including:

a second transmission module, configured to perform downlink transmission based on fixed frame period FFP configuration information and a channel state, where the FFP configuration information includes at least one of an FFP start location and an FFP length of the network-side device and at least one of an FFP start location and an FFP length of a terminal, and the FFP start location of the network-side device is different from the FFP start location of the terminal.

According to a fifth aspect, an embodiment of the present disclosure further provides a communication device, where the communication device includes a processor, a memory, and a computer program that is stored in the memory and that runs on the processor, and when executing the computer program, steps of the data transmission method for an unlicensed band are implemented.

According to a sixth aspect, an embodiment of the present disclosure provides a computer-readable storage medium, where the computer-readable storage medium stores a computer program, and when the computer program is executed by a processor, steps of the data transmission method for an unlicensed band are implemented.

In the foregoing solution, the terminal performs uplink transmission based on the FFP configuration information and the channel state, and the network-side device performs downlink transmission based on the FFP configuration information and the channel state. The FFP start location of the network-side device is different from the FFP start location of the terminal. In this way, the network-side device and the terminal can share Channel Occupancy Time (COT) of the other party for transmission or initiate COT for transmission, so that the network-side device and the terminal flexibly share a transmission channel

### BRIEF DESCRIPTION OF DRAWINGS

The technical solutions of the embodiments of the present disclosure are described together with accompanying drawings. The following briefly describes the accompanying drawings. Apparently, the accompanying drawings in the following description show merely some embodiments of the present disclosure, and a person of ordinary skill in the art may still derive other drawings from these accompanying drawings without creative efforts.

FIG. 1 is a block diagram of a mobile communications system applicable to an embodiment of the present disclosure;

FIG. 2 is a schematic diagram of an operation of an initiating device;

FIG. 3 is a schematic flowchart of a data transmission method for an unlicensed band of a terminal according to an embodiment of the present disclosure;

FIG. 4 is a schematic flowchart of a data transmission method for an unlicensed band of a network-side device according to an embodiment of the present disclosure;

FIG. 5 is a schematic diagram showing that an FFP start location of UE is later than an FFP start location of a gNB in Embodiment 1 of the present disclosure;

FIG. 6 is a schematic diagram showing that an FFP start location of UE is later than an FFP start location of a gNB in Embodiment 2 of the present disclosure;

FIG. 7 is a schematic diagram showing that an FFP start location of UE is later than an FFP start location of a gNB in Embodiment 3 of the present disclosure;

FIG. 8 is a schematic diagram showing that an FFP start location of UE is later than an FFP start location of a gNB and COT of the UE and COT of the gNB do not overlap in Embodiment 4 of the present disclosure;

FIG. 9 is a schematic diagram showing that an FFP start location of a gNB is later than an FFP start location of UE in Embodiment 5 of the present disclosure;

FIG. 10 is a schematic diagram of a module structure of a terminal according to an embodiment of the present disclosure;

FIG. 11 is a schematic diagram of a module structure of a network-side device according to an embodiment of the present disclosure;

FIG. 12 is a schematic diagram of composition of a terminal according to an embodiment of the present disclosure; and

FIG. 13 is a schematic diagram of composition of a network-side device according to an embodiment of the present disclosure.

### DETAILED DESCRIPTION

Example embodiments of the present disclosure are described in more detail below with reference to the accompanying drawings. Although the example embodiments of the present disclosure are shown in the accompanying drawings, it should be understood that the present disclosure may be implemented in various forms without being limited to the embodiments described herein. Instead, these embodiments are provided to provide a more thorough understanding of the present disclosure and to convey the scope of the present disclosure to those skilled in the art in its entirety.

Terms “first” and “second” in the specification and claims of this application are used to distinguish between similar objects, and do not need to be used to describe a specific order or sequence. It should be understood that data used in this way may be interchangeable in appropriate cases, so that the embodiments of this application described herein can be implemented in a sequence other than those shown or described herein. In addition, terms “include”, “have”, and any modification thereof are intended to cover non-exclusive inclusion, for example, processes, methods, systems, products, or devices that contain a series of steps or units are not necessarily limited to those steps or units that are clearly listed, but may include other steps or units that are not clearly listed or are inherent to these processes, methods, products, or devices. “and/or” in the specifications and claims represent at least one of connected objects.

The technology described in the present disclosure is not limited to a Long Term Evolution (LTE) system or an LTE-Advanced (LTE-A) system, and may also be used in various wireless communications systems, for example, Code Division Multiple Access (CDMA), Time Division Multiple Access (TDMA), Frequency Division Multiple Access (FDMA), Orthogonal Frequency Division Multiple Access (OFDMA), Single-Carrier Frequency-Division Multiple Access (SC-FDMA), and another system. The terms “system” and “network” are often exchanged in use. A CDMA system may implement a radio technology such as CDMA 2000 or Universal Terrestrial Radio Access (UTRA). UTRA includes Wideband CDMA (WCDMA) and another CDMA variation. A TDMA system may implement a radio technology such as Global System for Mobile Communication (GSM). An OFDMA system may implement radio technologies such as Ultra Mobile Broadband (UMB), Evolution-UTRA (E-UTRA), IEEE 802.11 (Wireless Fidelity (Wi-Fi)), IEEE 802.16 (Worldwide Interoperability for Microwave Access (WiMAX)), IEEE 802.20, and Flash-OFDM. UTRA and E-UTRA are parts of a Universal Mobile Telecommunications System (UTMS). LTE and LTE-A are new UMTS versions that use E-U IRA. UTRA, E-UTRA, UMTS, LTE, LTE-A, and GSM are described in a document of an organization named “3rd Generation Partnership Project” (3GPP). CDMA 2000 and UMB are described in a document of an origination named “3rd Generation Partnership Project 2” (3GPP2). The technology described in the present disclosure may also be used in the foregoing system and radio technology, and may also be used in another system and radio technology. However, a New Radio (NR) system is described below as an example, and the term NR is used in most of the descriptions, although these technologies can also be used in an application other than an application of the NR system.

The following description provides examples without limiting the scope, suitability, or configuration set forth in the claims. The functions and arrangements of the elements under discussion may be changed without departing from the spirit and scope of the present disclosure. Examples may appropriately omit, replace, or add various procedures or components. For example, the described method may be performed in a different order from described, and steps may be added, omitted, or combined. In addition, features described with reference to some examples may be combined in other examples.

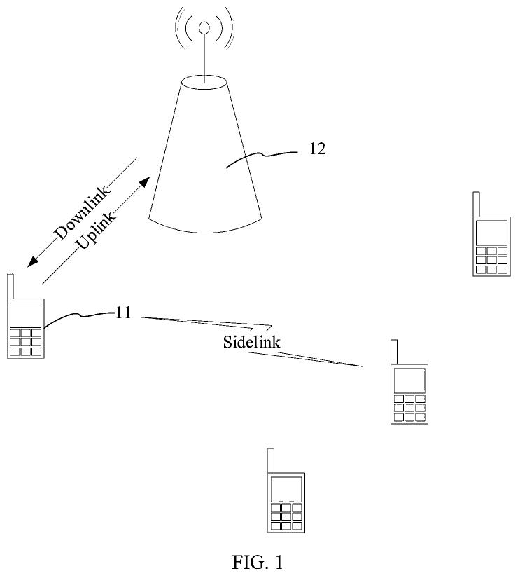

FIG. 1 is a block diagram of a mobile communications system applicable to an embodiment of the present disclosure.

The wireless communications system includes a terminal 11 and a network-side device 12. The terminal 11 may also be referred to as a terminal device or UE. The terminal 11 may be a terminal-side device such as a mobile phone, a tablet personal computer, a laptop computer, a Personal Digital Assistant (PDA), a Mobile Internet Device (MID), a wearable device, or an in-vehicle device. It should be noted that a specific type of the terminal 11 is not limited in the embodiments of the present disclosure. The network-side device 12 may be a base station or a core network, where the base station may be a fifth generation (5G) base station or a base station (such as a gNB, a 5G NR NB, or the like) of a later version, or a base station in another communications system (such as an evolved NodeB (eNB), a Wireless Local Area Network (WLAN) access point, or another access point), or may be a location server (such as an Evolved Serving Mobile Location Center (E-SMLC) or a Location Manager Function (LMF)), and the base station may be referred to as a NodeB, an evolved NodeB, an access point, a Base Transceiver Station (BTS), a radio base station, a radio transceiver, a Basic Service Set (BSS), an Extended Service Set (ESS), a NodeB, an eNB, a home NodeB, a home evolved NodeB, a WLAN access point, a WiFi node, or another appropriate term in the field. Provided that a same technical effect is achieved, the base station is not limited to a specific technical vocabulary. It should be noted that, in the embodiments of the present disclosure, only a base station in an NR system is used as an example, but a specific type of the base station is not limited.

The base station may communicate with the terminal 11 under the control of a base station controller. In various examples, the base station controller may be a part of a core network or some base stations. Some base stations may communicate control information or user data with a core network through backhaul. In some examples, some of these base stations may communicate directly or indirectly with each other by using a backhaul link, and the backhaul link may be a wired or wireless communication link. The wireless communications system may support operations on multiple carriers (waveform signals of different frequencies). A multi-carrier transmitter can simultaneously transmit modulated signals on the multiple carriers. For example, each communication link may be a multi-carrier signal modulated according to various radio technologies. Each modulated signal may be sent on a different carrier and may carry control information (for example, a reference signal or a control channel), overhead information, data, and the like.

The base station may perform wireless communication with the terminal 11 by using one or more access point antennas. Each base station may provide communication coverage for a respective corresponding coverage area. The coverage area of the access point may be divided into sectors that constitute only a part of the coverage area. The wireless communications system may include different types of base stations (for example, macro base stations, micro base stations, or femto base stations). The base station may also use different radio technologies, such as cellular or WLAN radio access technologies. The base station may be associated with a same access network or operator deployment or different access network or operator deployments. Coverage areas of different base stations (including coverage areas of base stations of a same type or different types, coverage areas using a same radio technology or different radio technologies, or coverage areas belonging to a same access network or different access networks) may overlap.

The communication link in the wireless communications system may include an uplink used to carry Uplink (UL) transmission (for example, from the terminal 11 to the network-side device 12), or a downlink used to carry Downlink (DL) transmission (for example, from the network-side device 12 to the terminal 11), and a Sidelink (SL) used to carry transmission between the terminal 11 and another terminal 11. UL transmission may also be referred to as reverse link transmission, and DL transmission may also be referred to as forward link transmission. Downlink transmission may be performed by using a licensed band, an unlicensed band, or both. Similarly, uplink transmission may be performed by using a licensed band, an unlicensed band, or both.

In a future communications system, an unlicensed band can be used as a supplement to a licensed band to help an operator expand a service. To maintain consistency with deployment of NR and maximize NR-based unlicensed access as much as possible, the unlicensed band may work on bands of 5 GHz, 37 GHz, and 60 GHz. High bandwidth (80 or 100 MHz) of the unlicensed band can reduce implementation complexity of the base station and the terminal (UE). The unlicensed band is shared by multiple Radio Access Technologies (RATs), such as WiFi, radar, LTE-License Assisted Access (LAA). Therefore, in some countries or regions, the unlicensed band must comply with a regulation during use, to ensure that all devices can use the resource fairly, such as regulations such as LBT and MCOT. When a transmission node needs to perform LBT first before sending information, ED is performed on a surrounding node. When detected power is less than a threshold, it is considered that a channel is idle, and the transmission node can send the information. Otherwise, it is considered that the channel is busy, and the transmission node cannot send the information. The transmission node may be a base station, UE, a WiFi Access Point (AP), or the like. After the transmission node starts transmission, occupied COT cannot exceed MCOT.

FBE means that a periodic structure is used for sending and/or receiving timing of a device, and a period of the FBE is an FFP.

An FBE node uses an LBT-based channel access mechanism to occupy a channel A node that initiates a transmission sequence that includes one or more consecutive transmissions is referred to as an initiating device, and another node is referred to as a responding device. The FBE node may be an initiating device, a responding device, or support functions of both the two nodes.

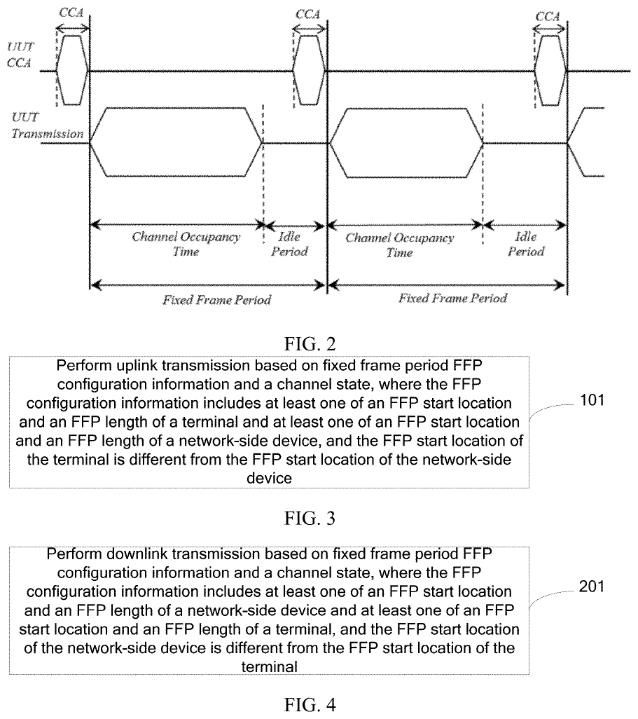

For an example of an operation of the initiating device, reference may be made to FIG. 2, where UUT is a Unit Under Test. Operation requirements include:

A fixed frame period value set supported by the node is set by a device manufacturer, and all values are in a range of 1 ms to 10 ms. Transmission can only be started at start time of a fixed frame period. The node can change a fixed frame period that is currently used by the node, but a changing frequency cannot be higher than 200 ms each time.

Before starting transmission at a start moment of a specific fixed frame period, the initiating device performs Clear Channel Assess (CCA). If it is determined that the fixed frame period is idle, the fixed frame period may be sent immediately. Otherwise, sending is not allowed in a following fixed frame period (except short control signaling transmissions specified in supervision requirements). In other words, before transmission, the initiating device needs to perform one-shot LBT, that is, Cat.2 LBT.

In a fixed frame period in which sending has started, total duration in which a corresponding initiating device can perform transmission without re-estimating availability of a channel is defined as COT. The initiating device may perform transmission for multiple times on a specified channel within the COT without performing additional CCA, provided that a time interval between adjacent transmissions in these transmissions does not exceed 16 μs. If a time interval between adjacent transmissions in the COT exceeds 16 μs, before continuing transmission, the initiating device needs to perform additional CCA, and continue transmission only when determining, through CAA, that the channel is idle. Time intervals between all adjacent transmissions are included in the COT.

The initiating device may authorize use rights of a specified channel in a specific period of time in the COT to one to more associated responding devices for transmission.

The COT cannot be longer than 95% of the fixed frame period, and is immediately followed by an idle period after the COT. The idle period lasts until a start moment of a next fixed frame period. In this way, a length of the idle period is at least 5% of the fixed frame period, and a minimum value is 100 μs.

After correctly receiving a data packet for a node, the node may directly transmit, without performing CCA, a management and control frame (for example, an Acknowledgement (ACK) frame) corresponding to the data packet on a specified channel This node needs to ensure that these consecutive transmitted frames do not exceed the above-mentioned maximum COT.

After receiving a grant for the use of the specified channel within a specific period of time, the responding device performs the following operations:

If the responding device initiates transmission after a maximum interval of 16 μs after the last transmission indicated and granted by the initiating device ends, the responding device does not need to perform CCA before performing transmission; otherwise, performs CCA before a granted transmission period starts. If it is determined that the channel is busy, the grant is discarded; otherwise, transmission may be started on the specified channel, at most a remaining part of COT in a current fixed frame period can be occupied, and multiple transmissions can be started in a time range of the remaining part, provided that a time interval between adjacent transmissions does not exceed 16 μs. After transmission is completed, the grant is discarded.

In a related protocol, when a system uses an FBE access mechanism, only the base station (gNB) can perform LBT before FFP. When a channel is idle, the gNB performs downlink transmission. When receiving any downlink channel or signal, the UE may share COT of the gNB for uplink transmission. The downlink signal or channel may be any downlink signal such as a Synchronization Signal Block (SSB), a Physical Downlink Control Channel (PDCCH), or a Demodulation Reference Signal (DMRS).

In the related technology, downlink signal detection needs to be performed for any uplink transmission, and UE can perform transmission only after detecting a downlink signal, regardless of uplink transmission with dynamic grant or uplink transmission with configured grant. For transmission with configured grant, if a gNB end cannot occupy a channel, the UE cannot perform transmission with configured grant even if a channel at a UE end is idle. This reduces efficiency of transmission with configured grant. In addition, for initial access or transmission with configured grant, the gNB does not know when the UE accesses or when data needs to be transmitted. To ensure access or transmission of the UE as much as possible, the gNB needs to frequently perform listening to preempt a channel, and send a downlink signal and/or a channel, thereby bringing unnecessary sending of redundant signals.

An embodiment of the present disclosure provides a data transmission method for an unlicensed band, applied to a terminal. As shown in FIG. 3, the method includes:

Step 101: Perform uplink transmission based on fixed frame period FFP configuration information and a channel state, where the FFP configuration information includes at least one of an FFP start location and an FFP length of the terminal and at least one of an FFP start location and an FFP length of a network-side device, and the FFP start location of the terminal is different from the FFP start location of the network-side device.

In this embodiment, the terminal performs uplink transmission based on the FFP configuration information and the channel state. The FFP start location of the network-side device is different from the FFP start location of the terminal. In this way, the terminal may share COT of the network-side device for transmission or initiate COT for transmission, so that the network-side device and the terminal can flexibly share a transmission channel

In an example embodiment of the present disclosure, the FFP configuration information is sent by the network-side device. The FFP configuration information may be carried by using a Radio Resource Control (RRC) message or physical layer signaling. The FFP start location may be an absolute time domain location or an offset value relative to a reference location, where the offset value may be an integer, and the reference location may be predefined, preconfigured by the network-side device, or configured by the network-side device.

In an example embodiment of the present disclosure, the FFP length of the terminal is different from the FFP length of the network-side device; or the FFP length of the terminal is the same as the FFP length of the network-side device.

In an example embodiment of the present disclosure, the FFP start location of the terminal is later than the FFP start location of the network-side device, and the performing uplink transmission based on FFP configuration information and a channel state includes:

performing at least one of the following operations in an FFP idle time period indicated by the FFP configuration information: clear channel assess CCA to obtain the channel state, downlink signal detection to obtain a detection result, and downlink channel detection to obtain a detection result; and

determining, based on at least one of the channel state and the detection result, whether to perform uplink transmission.

In an example embodiment of the present disclosure, if the FFP start location of the terminal is later than the FFP start location of the network-side device, uplink transmission resources in the first X symbols of an FFP of the terminal are invalid, and X is an integer greater than or equal to 1.

In an example embodiment of the present disclosure, the determining, based on the channel state, whether to perform uplink transmission includes any one of the following:

if the terminal detects a downlink signal or a downlink channel and detects that the channel is idle, performing uplink transmission;

if the terminal detects a downlink signal or a downlink channel and detects that the channel is busy, skipping performing uplink transmission;

if the terminal does not detect a downlink signal or a downlink channel and detects that the channel is idle, performing uplink transmission; and

if the terminal does not detect a downlink signal or a downlink channel and detects that the channel is busy, skipping performing uplink transmission.

That the terminal does not detect the downlink signal or the downlink channel includes either of the following cases: The terminal performs downlink signal detection and/or downlink channel detection, but does not detect a downlink signal or a downlink channel; or the terminal does not perform downlink signal detection or downlink channel detection.

In an example embodiment of the present disclosure, the performing uplink transmission includes either of the following:

sharing, by the terminal, channel occupancy time COT of the network-side device to perform uplink transmission, where transmission duration does not exceed the COT of the network-side device; and

initiating, by the terminal, COT to perform uplink transmission.

The COT of the network-side device may overlap or may not overlap the COT of the terminal.

In an example, the uplink transmission is physical random access channel PRACH transmission, and the performing uplink transmission includes either of the following:

if the terminal detects a downlink signal or a downlink channel and detects that the channel is idle, selecting, by the terminal, any random access channel RACH occasion in an FFP of the terminal to perform PRACH transmission, where transmission duration does not exceed the COT of the network-side device; and

if the terminal does not detect a downlink signal or a downlink channel and detects that the channel is idle, performing, by the terminal, PRACH transmission at a first RACH occasion in an FFP of the terminal.

In an example embodiment of the present disclosure, the initiating, by the terminal, COT to perform uplink transmission includes either of the following:

receiving first indication information of the network-side device, where the first indication information indicates that the terminal is allowed to initiate COT to perform uplink transmission; or

determining, by the terminal, whether to initiate COT.

In an example embodiment of the present disclosure, before the sharing, by the terminal, COT of the network-side device to perform uplink transmission, the method further includes:

receiving second indication information of the network-side device, where the second indication information indicates that the terminal is allowed to share the COT of the network-side device.

In an example embodiment of the present disclosure, the FFP start location of the terminal is earlier than the FFP start location of the network-side device, and the method further includes:

sending third indication information to the network-side device, where the third indication information indicates that the network-side device is allowed to share the COT of the terminal.

An embodiment of the present disclosure provides a data transmission method for an unlicensed band, applied to a network-side device. As shown in FIG. 4, the method includes:

Step 201: Perform downlink transmission based on fixed frame period FFP configuration information and a channel state, where the FFP configuration information includes at least one of an FFP start location and an FFP length of the network-side device and at least one of an FFP start location and an FFP length of a terminal, and the FFP start location of the network-side device is different from the FFP start location of the terminal.

In this embodiment, the network-side device performs downlink transmission based on the FFP configuration information and the channel state, and the FFP start location of the network-side device is different from the FFP start location of the terminal. In this way, the network-side device can share COT of the terminal for transmission or initiate COT for transmission, so that the network-side device and the terminal flexibly share a transmission channel

In an example embodiment of the present disclosure, the FFP configuration information is sent by the network-side device. The method further includes:

sending the FFP configuration information to the terminal.

The FFP configuration information may be carried by using a RRC message or physical layer signaling.

The FFP start location may be an absolute time domain location or an offset value relative to a reference location, where the offset value may be an integer, and the reference location may be predefined, preconfigured by the network-side device, or configured by the network-side device.

In an example embodiment of the present disclosure, the FFP length of the terminal is different from the FFP length of the network-side device; or

the FFP length of the terminal is the same as the FFP length of the network-side device.

In an example embodiment of the present disclosure, the FFP start location of the network-side device is later than the FFP start location of the terminal, and the performing downlink transmission based on FFP configuration information and a channel state includes:

performing at least one of the following operations in an FFP idle time period indicated by the FFP configuration information: clear channel assess CCA to obtain the channel state, uplink signal detection to obtain a detection result, and uplink channel detection to obtain a detection result; and

determining, based on at least one of the channel state and the detection result, whether to perform downlink transmission.

In an example embodiment of the present disclosure, the determining, based on the channel state, whether to perform downlink transmission includes any one of the following:

if the network-side device detects an uplink signal or an uplink channel and detects that the channel is idle, performing downlink transmission;

if the network-side device detects an uplink signal or an uplink channel and detects that the channel is busy, skipping performing downlink transmission;

if the network-side device does not detect an uplink signal or an uplink channel and detects that the channel is idle, performing downlink transmission; and

if the network-side device does not detect an uplink signal or an uplink channel and detects that the channel is busy, skipping performing downlink transmission.

That the network-side device does not detect the uplink signal or the uplink channel includes either of the following cases: The network-side device performs uplink signal detection and/or uplink channel detection, but does not detect an uplink signal or an uplink channel; or the network-side device does not perform uplink signal detection or uplink channel detection.

In an example embodiment of the present disclosure, the performing downlink transmission includes either of the following:

sharing, by the network-side device, COT of the terminal to perform downlink transmission, where transmission duration does not exceed the COT of the terminal; and

initiating, by the network-side device, COT to perform downlink transmission.

In an example embodiment of the present disclosure, before the sharing, by the network-side device, COT of the terminal to perform downlink transmission, the method further includes:

receiving third indication information of the terminal, where the third indication information indicates that the network-side device is allowed to share the COT of the terminal.

In an example embodiment of the present disclosure, the FFP start location of the terminal is later than the FFP start location of the network-side device, and the method further includes:

sending second indication information to the terminal, where the second indication information indicates that the terminal is allowed to share COT of the network-side device.

In an example embodiment of the present disclosure, the method further includes:

sending first indication information to the terminal, where the first indication information indicates that the terminal is allowed to initiate COT to perform uplink transmission.

Technical solutions in the present disclosure are further described below with reference to the accompanying drawings and embodiments.

### Embodiment 1

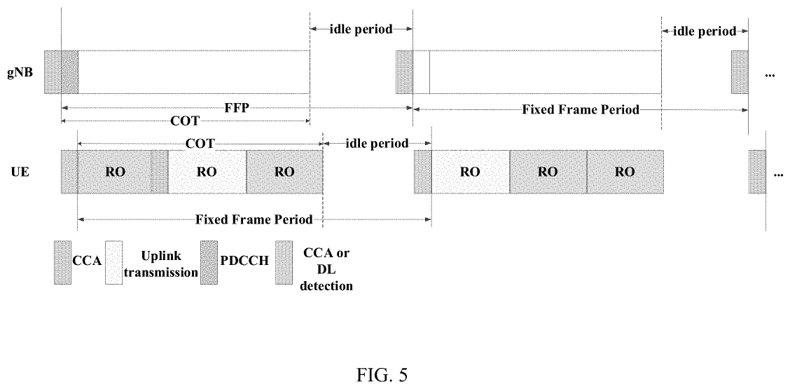

In this embodiment, as shown in FIG. 5, an FFP start location of UE is after an FFP of a gNB, and the FFP start location of the UE and the FFP start location the gNB are different by at least one Orthogonal Frequency Division Multiplexing symbol (OS), and COT of the UE and COT of the gNB overlap. The UE performs at least one of CCA and downlink signal detection in an idle period of an FFP of the UE. When detecting a downlink signal, the UE may perform uplink transmission in the COT of the gNB according to an instruction of the gNB or a default regulation. If the UE detects no downlink signal in the idle period of the UE and CCA detection shows that a channel is idle, the UE initiates an FFP for uplink transmission.

### Embodiment 2

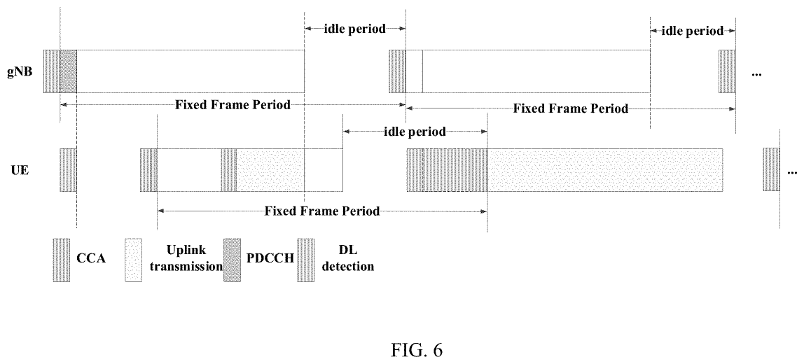

In this embodiment, an FFP start location of UE is far later than an FFP of a gNB. As shown in FIG. 6, detection of a DL signal of the gNB is far earlier than CCA. In this case, the UE performs DL signal detection from an FFP start location of the gNB. When detecting the DL signal, the UE may perform uplink transmission in remaining COT of the gNB. If the UE does not detect the DL signal at the FFP start location of the gNB, the UE stops detecting until the UE performs CCA before an FFP of the UE. If a channel is idle, the UE performs corresponding uplink transmission. In addition, when detecting no DL signal, the UE may constantly perform DL signal detection until time for CCA in an idle period. If the UE detects any DL signal, the UE may share COT of the gNB. If the UE has not detected a DL signal, the UE performs LBT at a location of CCA, and determines, based on a listening result, whether to perform uplink transmission.

### Embodiment 3

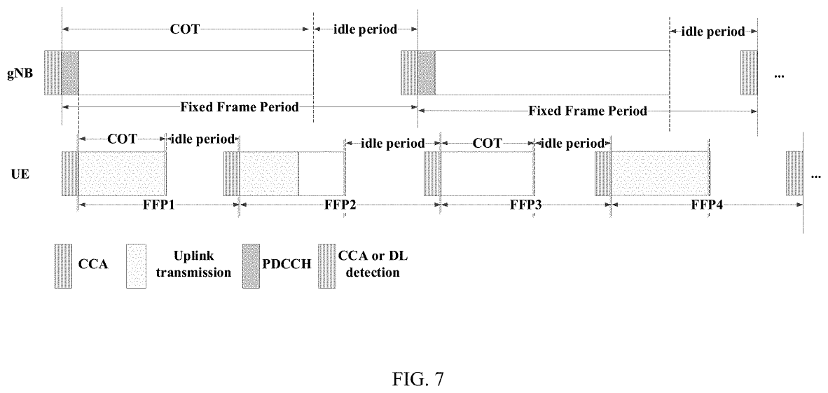

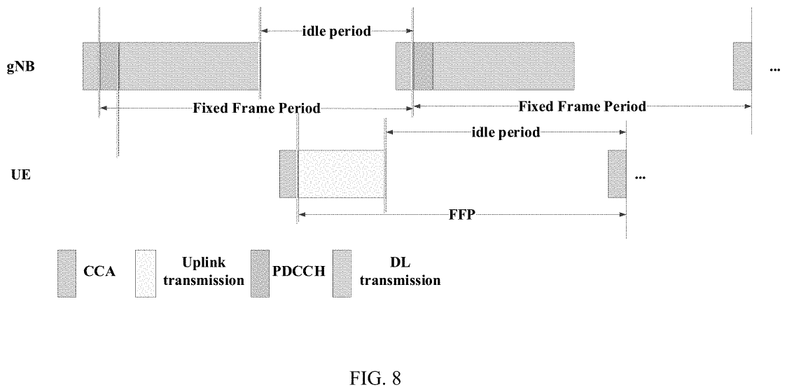

In this embodiment, as shown in FIG. 7, an FFP of UE starts after an FFP of a gNB, and the FFP of the UE is far less than the FFP of the gNB, that is, there is one extra FFP start location of the UE in COT of the gNB. In this case, if the UE detects a DL signal of the gNB, the UE may share the COT of the gNB, as shown in FFP 1 and FFP 2 in the figure. In addition, even if the UE detects the DL signal of the gNB, the UE may choose to initiate COT of the UE, as shown by FFP 4 in the figure. In this case, transmission duration of the UE may be greater than remaining COT of the gNB. Further, behavior of the UE may be indicated by the gNB, and when sending the DL signal, the gNB may indicate whether the UE needs to initiate COT in FFP 4.

Further, in Embodiment 1, Embodiment 2, and Embodiment 3, if the UE performs random access, after the UE detects a downlink signal in an idle period, the UE may randomly select one of random access channel occasions (Random Access Channel occasion, RO) configured in the FFP, to perform Physical Random Access Channel (PRACH) transmission, and transmission duration does not exceed the remaining COT of the gNB. If the UE detects no downlink signal in the idle period and CCA detection shows that the channel is idle, the UE performs PRACH transmission on the first RO in RACH occasion configured in the FFP, as shown in FIG. 5.

Similarly, for UE that performs transmission with configured grant, if the UE detects a downlink signal in an idle period, the UE may perform CG transmission in the COT of the gNB. If the UE detects no downlink signal in the idle period, and CCA detection shows that the channel is idle, the UE performs CG transmission from the FFP start location of the UE.

In addition, for configured uplink transmission, for example, a PRACH, a Scheduling Request (SR), a Common Group (CG), or Physical Uplink Shared Channel (PUSCH) of 2-step RACH MSGA, if a transmission resource falls on the first X symbols of the FFP, resources in the X symbols are invalid, where X≥1. X depends on signal processing time or uplink-downlink conversion time.

### Embodiment 4

In this embodiment, as shown in FIG. 8, an FFP start location of UE is later than an FFP of the gNB, and COT of the UE does not overlap the FFP of the gNB, the gNB and the UE may separately perform CCA, and perform transmission in respective COT based on a channel listening result.

### Embodiment 5

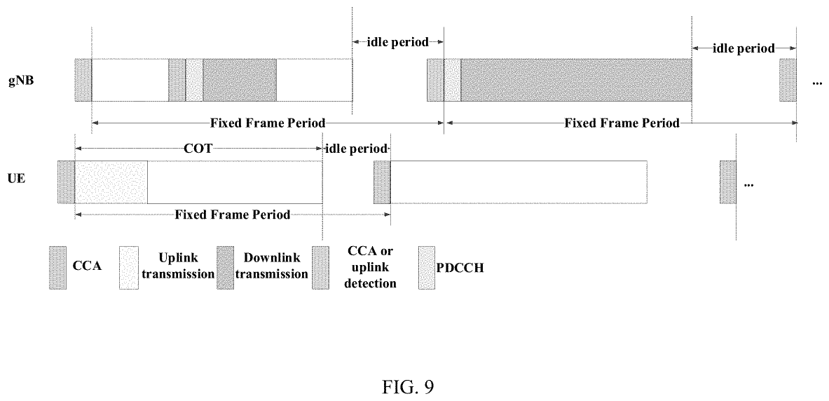

In this embodiment, as shown in FIG. 9, an FFP start location of a gNB may be later than an FFP start location of UE. In this case, the gNB needs to perform at least one of UL signal detection or CCA. If the gNB detects a UL signal, the gNB determines, based on the uplink signal, for example, a CG-Uplink Control Information (UCI) indication, whether COT of the UE can be shared or a time length of COT that can be shared. If the gNB detects no UL signal, and CCA detection shows that a channel is idle, the gNB initiates COT to perform downlink transmission.

In addition, in a case that the FFP start location of the gNB is later than the FFP start location of the UE, the gNB performs UL signal detection from the FFP start location of the UE. When a UL signal is detected, the gNB may perform uplink transmission in remaining COT of the UE. If the UE detects no DL signal at the FFP start location of the gNB, the UE stops detection until the UE performs CCA before an FFP of the UE. If a channel is idle, the UE performs corresponding uplink transmission. In addition, when detecting no UL signal, the gNB may constantly perform UL signal detection until time for CCA in an idle period. If the gNB detects any UL signal, the gNB may share COT of the UE. If the gNB has not detected a UL signal, the gNB performs LBT at a location of CCA, and determines, based on a listening result, whether to perform downlink transmission.

If the FFP of the gNB starts after the FFP of the UE, and the FFP of the gNB is far less than the FFP of the UE, that is, there is one extra FFP start location of the gNB in COT of the UE. In this case, if the gNB detects any UL signal of the UE, the gNB may share the COT of the UE. In addition, even if the gNB detects the UL signal of the UE, the gNB may choose to initiate COT of the gNB. In this case, transmission duration of the gNB may be greater than remaining COT of the UE.

In the foregoing embodiment, the gNB may notify the UE of FFP-related information by using an RRC message or physical layer signaling.

The foregoing start location may be an absolute time domain location, or may be an offset value relative to a reference location. For example, if the gNB and the UE have a common reference location, the FFP start location of the gNB and the FFP start location of the UE are offset values relative to the reference location. If the FFP start location of the gNB is an absolute location, the FFP start location of the UE may be an offset relative to the FFP start location of the gNB. If the FFP start location of the UE is an absolute location, the FFP start location of the gNB may be an offset relative to the FFP start location of the UE. The offset value may be 0, or may be any positive or negative integer.

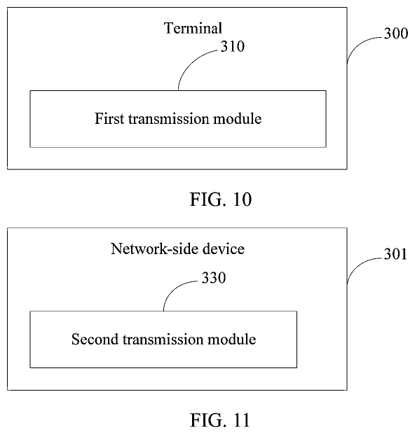

As shown in FIG. 10, a terminal 300 in an embodiment of the present disclosure includes a data transmission apparatus for an unlicensed band, which can implement a data transmission method for an unlicensed band that is applied to the terminal in the foregoing embodiment, and achieve a same effect. The terminal 300 includes the following function module:

a first transmission module 310, configured to perform uplink transmission based on fixed frame period FFP configuration information and a channel state, where the FFP configuration information includes at least one of an FFP start location and an FFP length of the terminal and at least one of an FFP start location and an FFP length of a network-side device, and the FFP start location of the terminal is different from the FFP start location of the network-side device.

In this embodiment, the terminal performs uplink transmission based on the FFP configuration information and the channel state. The FFP start location of the network-side device is different from the FFP start location of the terminal. In this way, the terminal may share COT of the network-side device for transmission or initiate COT for transmission, so that the network-side device and the terminal can flexibly share a transmission channel

In an example embodiment of the present disclosure, the FFP configuration information is sent by the network-side device. The FFP configuration information may be carried by using an RRC message or physical layer signaling.

The FFP start location may be an absolute time domain location or an offset value relative to a reference location, where the offset value may be an integer, and the reference location may be predefined, preconfigured by the network-side device, or configured by the network-side device.

In an example embodiment of the present disclosure, the FFP length of the terminal is different from the FFP length of the network-side device; or the FFP length of the terminal is the same as the FFP length of the network-side device.

In an example embodiment of the present disclosure, the FFP start location of the terminal is later than the FFP start location of the network-side device, and the first transmission module 310 is configured to perform at least one of the following operations in an FFP idle period indicated by the FFP configuration information: clear channel assess CCA to obtain the channel state, downlink signal detection to obtain a detection result, and downlink channel detection to obtain a detection result; and determining, based on at least one of the channel state and the detection result, whether to perform uplink transmission.

In an example embodiment of the present disclosure, if the FFP start location of the terminal is later than the FFP start location of the network-side device, uplink transmission resources in the first X symbols of an FFP of the terminal are invalid, and X is an integer greater than or equal to 1.

In an example embodiment of the present disclosure, the first transmission module 310 is configured to perform any one of the following:

if the terminal detects a downlink signal or a downlink channel and detects that the channel is idle, performing uplink transmission;

if the terminal detects a downlink signal or a downlink channel and detects that the channel is busy, skipping performing uplink transmission;

if the terminal does not detect a downlink signal or a downlink channel and detects that the channel is idle, performing uplink transmission; and

if the terminal does not detect a downlink signal or a downlink channel and detects that the channel is busy, skipping performing uplink transmission.

That the terminal does not detect the downlink signal or the downlink channel includes either of the following cases: The terminal performs downlink signal detection and/or downlink channel detection, but does not detect a downlink signal or a downlink channel; or the terminal does not perform downlink signal detection or downlink channel detection.

In an example embodiment of the present disclosure, the first transmission module 310 is configured to perform either of the following:

sharing, by the terminal, channel occupancy time COT of the network-side device to perform uplink transmission, where transmission duration does not exceed the COT of the network-side device; and

initiating, by the terminal, COT to perform uplink transmission.

The COT of the network-side device may overlap or may not overlap the COT of the terminal.

In an example, the uplink transmission is physical random access channel PRACH transmission, and the first transmission module 310 is configured to perform either of the following:

if the terminal detects a downlink signal or a downlink channel and detects that the channel is idle, selecting, by the terminal, any random access channel RACH occasion in an FFP of the terminal to perform PRACH transmission, where transmission duration does not exceed the COT of the network-side device; and

if the terminal does not detect a downlink signal or a downlink channel and detects that the channel is idle, performing, by the terminal, PRACH transmission at a first RACH occasion in an FFP of the terminal.

In an example embodiment of the present disclosure, the first transmission module 310 is configured to perform either of the following:

receiving first indication information of the network-side device, where the first indication information indicates that the terminal is allowed to initiate COT to perform uplink transmission; or

determining, by the terminal, whether to initiate COT.

In an example embodiment of the present disclosure, the first transmission module 310 is further configured to: receive second indication information of the network-side device, where the second indication information indicates that the terminal is allowed to share the COT of the network-side device.

In an example embodiment of the present disclosure, the FFP start location of the terminal is earlier than the FFP start location of the network-side device, and the first transmission module 310 is further configured to: send third indication information to the network-side device, where the third indication information indicates that the network-side device is allowed to share the COT of the terminal.

As shown in FIG. 11, a network-side device 301 in an embodiment of the present disclosure includes a data transmission apparatus for an unlicensed band, which can implement a data transmission method for an unlicensed band that is applied to the network-side device in the foregoing embodiment, and achieve a same effect. The network-side device 301 includes the following function module:

a second transmission module 330, configured to perform downlink transmission based on fixed frame period FFP configuration information and a channel state, where the FFP configuration information includes at least one of an FFP start location and an FFP length of the network-side device and at least one of an FFP start location and an FFP length of a terminal, and the FFP start location of the network-side device is different from the FFP start location of the terminal.

In this embodiment, the network-side device performs downlink transmission based on the FFP configuration information and the channel state, and the FFP start location of the network-side device is different from the FFP start location of the terminal. In this way, the network-side device can share COT of the terminal for transmission or initiate COT for transmission, so that the network-side device and the terminal flexibly share a transmission channel

In an example embodiment of the present disclosure, the FFP configuration information is sent by the network-side device. The second transmission module 330 is further configured to send the FFP configuration information to the terminal.

The FFP configuration information may be carried by using a RRC message or physical layer signaling.

The FFP start location may be an absolute time domain location or an offset value relative to a reference location, where the offset value may be an integer, and the reference location may be predefined, preconfigured by the network-side device, or configured by the network-side device.

In an example embodiment of the present disclosure, the FFP length of the terminal is different from the FFP length of the network-side device; or

the FFP length of the terminal is the same as the FFP length of the network-side device.

In an example embodiment of the present disclosure, the FFP start location of the network-side device is later than the FFP start location of the terminal, and the second transmission module 330 is configured to perform at least one of the following operations in an FFP idle period indicated by the FFP configuration information: clear channel assess CCA to obtain the channel state, uplink signal detection to obtain a detection result, and uplink channel detection to obtain a detection result; and determining, based on at least one of the channel state and the detection result, whether to perform downlink transmission.

In an example embodiment of the present disclosure, the second transmission module 330 is configured to perform any one of the following:

if the network-side device detects an uplink signal or an uplink channel and detects that the channel is idle, performing downlink transmission;

if the network-side device detects an uplink signal or an uplink channel and detects that the channel is busy, skipping performing downlink transmission;

if the network-side device does not detect an uplink signal or an uplink channel and detects that the channel is idle, performing downlink transmission; and

if the network-side device does not detect an uplink signal or an uplink channel and detects that the channel is busy, skipping performing downlink transmission.

That the network-side device does not detect the uplink signal or the uplink channel includes either of the following cases: The network-side device performs uplink signal detection and/or uplink channel detection, but does not detect an uplink signal or an uplink channel; or the network-side device does not perform uplink signal detection or uplink channel detection.

In an example embodiment of the present disclosure, the second transmission module 330 is configured to perform either of the following:

sharing, by the network-side device, COT of the terminal to perform downlink transmission, where transmission duration does not exceed the COT of the terminal; and

initiating, by the network-side device, COT to perform downlink transmission.

In an example embodiment of the present disclosure, the second transmission module 330 is further configured to: receive third indication information of the terminal, where the third indication information indicates that the network-side device is allowed to share the COT of the terminal.

In an example embodiment of the present disclosure, the FFP start location of the terminal is later than the FFP start location of the network-side device, and the second transmission module 330 is further configured to: send second indication information to the terminal, where the second indication information indicates that the terminal is allowed to share COT of the network-side device.

In an example embodiment of the present disclosure, the second transmission module 330 is further configured to: send first indication information to the terminal, where the first indication information indicates that the terminal is allowed to initiate COT to perform uplink transmission.

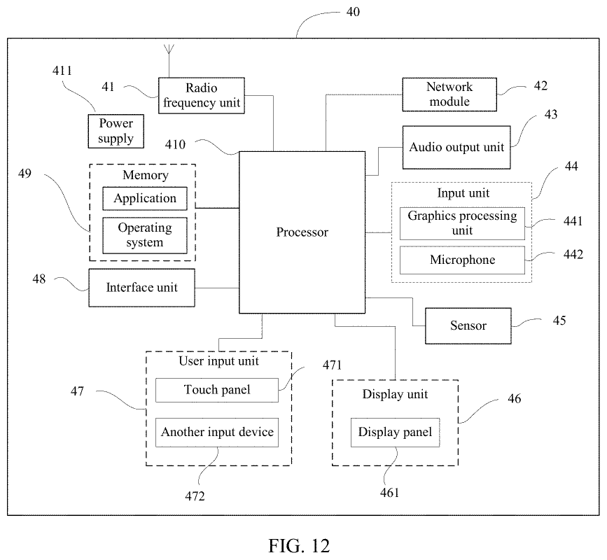

To better achieve the foregoing objective, further, FIG. 12 is a schematic diagram of a hardware structure of a terminal for implementing the embodiments of the present disclosure. The terminal 40 includes but is not limited to components such as a radio frequency unit 41, a network module 42, an audio output unit 43, an input unit 44, a sensor 45, a display unit 46, a user input unit 47, an interface unit 48, a memory 49, a processor 410, and a power supply 411. A person skilled in the art may understand that a structure of the terminal shown in FIG. 12 does not constitute a limitation on the terminal, and the terminal may include more or fewer components than those shown in the figure, or combine some components, or have different component arrangements. In this embodiment of the present disclosure, the terminal includes but is not limited to a mobile phone, a tablet computer, a laptop computer, a palmtop computer, an in-vehicle terminal, a wearable device, a pedometer, and the like.

The processor 410 is configured to perform uplink transmission based on fixed frame period FFP configuration information and a channel state, where the FFP configuration information includes at least one of an FFP start location and an FFP length of the terminal and at least one of an FFP start location and an FFP length of a network-side device, and the FFP start location of the terminal is different from the FFP start location of the network-side device.

It should be understood that, in this embodiment of the present disclosure, the radio frequency unit 41 may be configured to receive and send information or receive and send a signal in a call process. In some embodiments, after downlink data from a base station is received, the processor 410 processes the downlink data. In addition, uplink data is sent to the base station. Generally, the radio frequency unit 41 includes but is not limited to an antenna, at least one amplifier, a transceiver, a coupler, a low noise amplifier, a duplexer, and the like. In addition, the radio frequency unit 41 may further communicate with a network and another device by using a wireless communication system.

The terminal provides wireless broadband Internet access for the user by using the network module 42, for example, helping the user send and receive an email, browsing a web page, and accessing streaming media.

The audio output unit 43 may convert audio data received by the radio frequency unit 41 or the network module 42 or stored in the memory 49 into an audio signal and output as sound. In addition, the audio output unit 43 may further provide audio output (for example, call signal receiving sound or message receiving sound) related to a function performed by the terminal 40. The audio output unit 43 includes a loudspeaker, a buzzer, a telephone receiver, and the like.

The input unit 44 is configured to receive an audio or video signal. The input unit 44 may include a Graphics Processing Unit (GPU) 441 and a microphone 442. The graphics processing unit 441 processes image data of a static picture or a video obtained by an image capture apparatus (such as a camera) in a video capture mode or an image capture mode. A processed image frame may be displayed on the display unit 46. The image frame processed by the graphics processing unit 441 may be stored in the memory 49 (or another storage medium) or sent by using the radio frequency unit 41 or the network module 42. The microphone 442 may receive sound and can process such sound into audio data. The processed audio data may be output by being converted into a format that may be sent to a mobile communications base station by using the radio frequency unit 41 in a telephone call mode.

The terminal 40 further includes at least one sensor 45, such as an optical sensor, a motion sensor, and another sensor. In some embodiments, the optical sensor includes an ambient light sensor and a proximity sensor. The ambient light sensor may adjust luminance of the display panel 461 based on brightness of ambient light, and the proximity sensor may disable the display panel 461 and/or backlight when the terminal 40 approaches an ear. As a type of the motion sensor, an accelerometer sensor may detect magnitude of an acceleration in each direction (generally three axes), and may detect magnitude and a direction of gravity when being static. The accelerometer sensor may be used for recognizing a terminal gesture (for example, horizontal and vertical screen switching, a related game, or magnetometer posture calibration), a function related to vibration recognition (for example, a pedometer or a strike), or the like. The sensor 45 may further include a fingerprint sensor, a pressure sensor, an iris sensor, a molecular sensor, a gyroscope, a barometer, a hygrometer, a thermometer, an infrared sensor, and the like. This is not described herein.

The display unit 46 is configured to display information entered by the user or information provided for the user. The display unit 46 may include a display panel 461, and the display panel 461 may be configured in a form of a Liquid Crystal Display (LCD), an Organic Light-Emitting Diode (OLED), or the like.

The user input unit 47 may be configured to receive input digit or character information and generate key signal input related to user setting and function control of the terminal. In some embodiments, the user input unit 47 includes a touch panel 471 and another input device 472. The touch panel 471, also referred to as a touchscreen, may collect a touch operation performed by the user on or near the touch panel 471 (for example, an operation performed by the user on or near the touch panel 471 by using any suitable object or accessory such as a finger or a stylus). The touch panel 471 may include two parts: a touch detection apparatus and a touch controller. The touch detection apparatus detects a touch position of the user, detects a signal brought by the touch operation, and transmits the signal to the touch controller. The touch controller receives touch information from the touch detection apparatus, converts the touch information into contact coordinates, sends the contact coordinates to the processor 410, and can receive and execute a command sent by the processor 410. In addition, the touch panel 471 may be implemented by using multiple types such as a resistive type, a capacitive type, an infrared ray, and a surface acoustic wave. The user input unit 47 may include another input device 472 in addition to the touch panel 471. In some embodiments, the another input device 472 may include but is not limited to one or more of a physical keyboard, a function key (such as a volume control key or an on/off key), a trackball, a mouse, a joystick, and the like. Details are not described herein.

Further, the touch panel 471 may cover the display panel 461. After detecting the touch operation on or near the touch panel 471, the touch panel 471 transmits the touch operation to the processor 410 to determine a type of a touch event, and then the processor 410 provides corresponding visual output on the display panel 461 based on the type of the touch event. In FIG. 12, the touch panel 471 and the display panel 461 are used as two independent components to implement input and output functions of the terminal. However, in some embodiments, the touch panel 471 and the display panel 461 may be integrated to implement the input and output functions of the terminal. This is not specifically limited herein.

The interface unit 48 is an interface connecting an external apparatus to the terminal 40. For example, the external apparatus may include a wired or wireless headset port, an external power supply (or battery charger) port, a wired or wireless data port, a storage card port, a port configured to connect to an apparatus having an identification module, an audio Input/Output (I/O) port, a video I/O port, a headset port, and the like. The interface unit 48 may be configured to receive input (for example, data information and power) from the external apparatus and transmit the received input to one or more elements in the terminal 40, or may be configured to transmit data between the terminal 40 and the external apparatus.

The memory 49 may be configured to store a software program and various data. The memory 49 may mainly include a program storage area and a data storage area. The program storage area may store an operating system, an application program required by at least one function (such as a sound play function or an image play function), and the like. The data storage area may store data (such as audio data or an address book) or the like created based on use of the mobile phone. In addition, the memory 49 may include a high-speed random access memory, and may further include a non-volatile memory such as at least one magnetic disk storage component, a flash memory component, or another volatile solid-state storage component.

The processor 410 is a control center of the terminal, and is connected to all parts of the entire terminal by using various interfaces and lines, and performs various functions of the terminal and processes data by running or executing the software program and/or the module that are stored in the memory 49 and invoking the data stored in the memory 49, to implement overall monitoring on the terminal. The processor 410 may include one or more processing units. In some embodiments, the processor 410 may be integrated with an application processor and a modem processor. The application processor mainly processes an operating system, a user interface, an application program, and the like, and the modem processor mainly processes wireless communication. It may be understood that the modem processor may also not be integrated into the processor 410.

The terminal 40 may further include a power supply 411 (such as a battery) that supplies power to each component. In some embodiments, the power supply 411 may be logically connected to the processor 410 by using a power management system, to implement functions such as charging, discharging, and power consumption management by using the power management system.

In addition, the terminal 40 includes some function modules not shown, and details are not described herein.

An embodiment of the present disclosure further provides a communication device, including a processor 410, a memory 49, and a computer program that is stored in the memory 49 and that can run on the processor 410. When the computer program is executed by the processor 410, the processes of the embodiment of the data transmission method for an unlicensed band are implemented, and a same technical effect can be achieved. To avoid repetition, details are not described herein.

The communication device may be a terminal, and the terminal may be a device that provides voice and/or other service data connectivity for a user, a handheld device with a wireless connection function, or another processing device connected to a wireless modem. A wireless terminal may communicate with one or more core networks by using a Radio Access Network (RAN). The wireless terminal may be a terminal device, such as a mobile phone (or referred to as a “cellular” phone) and a computer having a mobile terminal. For example, the wireless terminal may be a portable, pocket-sized, handheld, computer-built-in, or in-vehicle mobile apparatus, and exchange language and/or data with the radio access network, for example, a device such as a Personal Communication Service (PCS) phone, a cordless telephone set, a Session Initiation Protocol (SIP) phone, a Wireless Local Loop (WLL) station, or a PDA. The wireless terminal may also be referred to as a system, a subscriber unit, a subscriber station, a mobile station, a mobile console, a remote station, a remote terminal, an access terminal , a user terminal, a user agent, and user equipment. This is not limited herein.

An embodiment of the present disclosure further provides a computer-readable storage medium. A computer program is stored in the computer-readable storage medium. When being executed by a processor, the processes of the embodiment of the data transmission method for an unlicensed band on the terminal side are implemented, and a same technical effect can be achieved. To avoid repetition, details are not described herein. The computer-readable storage medium includes a Read-Only Memory (ROM), a Random Access Memory (RAM), a magnetic disk, an optical disc, or the like.

To better implement the foregoing objectives, an embodiment of the present disclosure further provides a network-side device. The network-side device includes a processor, a memory, and a computer program that is stored in the memory and that can run on the processor. When executing the computer program, the processor implements the steps in the data transmission method for an unlicensed band, and a same technical effect can be achieved. To avoid repetition, details are not described herein again.

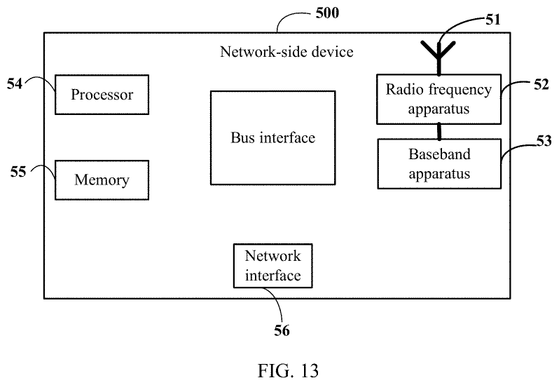

For example, an embodiment of the present disclosure further provides a network-side device. As shown in FIG. 13, the network-side device 500 includes an antenna 51, a radio frequency apparatus 52, and a baseband apparatus 53. The antenna 51 is connected to the radio frequency apparatus 52. In an uplink direction, the radio frequency apparatus 52 receives information by using the antenna 51, and sends the received information to the baseband apparatus 53 for processing. In a downlink direction, the baseband apparatus 53 processes to-be-sent information, and sends the to-be-sent information to the radio frequency apparatus 52. After processing the received information, the radio frequency apparatus 52 sends the information by using the antenna 51.

The foregoing data transmission apparatus for an unlicensed band may be located in the baseband apparatus 53. In the foregoing embodiment, a method performed by the network-side device may be implemented in the baseband apparatus 53. The baseband apparatus 53 includes a processor 54 and a memory 55.

For example, the baseband apparatus 53 may include at least one baseband board. Multiple chips are disposed on the baseband board. As shown in FIG. 13, one chip is, for example, the processor 54, and is connected to the memory 55, to invoke a program in the memory 55 to perform an operation of the network-side device shown in the foregoing method embodiment.

The baseband apparatus 53 may further include a network interface 56, configured to exchange information with the radio frequency apparatus 52, where the interface is, for example, a Common Public Radio Interface (CPRI).

The processor herein may be one processor, or may be a general name of multiple processing elements. For example, the processor may be a CPU, or may be an Application Specific Integrated Circuits (ASIC), or one or more integrated circuits configured to implement the method performed by the foregoing network-side device, for example, one or more microprocessors DSPs, or one or more Field Programmable Gate Arrays (FPGAs). A storage element may be one memory, or may be a general name of multiple storage elements.

The memory 55 may be a volatile memory or a non-volatile memory, or may include both a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a RAM, which is used as an external cache. By way of example instead of limitation, many forms of RAM are available, such as a Static RAM (SRAM), a Dynamic RAM (DRAM), a Synchronous DRAM (SDRAM), a Double Data Rate SDRAM (DDRSDRAM), an Enhanced SDRAM (ESDRAM), a Synchlink DRAM (SLDRAM), and a Direct Rambus RAM (DRRAM). The memory 55 described in this application is intended to include but is not limited to these and any other suitable type of memory.

In some embodiments, the network-side device in this embodiment of the present disclosure further includes a computer program that is stored in the memory 55 and that can run on the processor 54. The processor 54 invokes the computer program in the memory 55 to perform the method performed by the modules shown in FIG. 11.

For example, when being invoked by the processor 54, the computer program may be used to perform downlink transmission based on fixed frame period FFP configuration information and a channel state, where the FFP configuration information includes at least one of an FFP start location and an FFP length of the network-side device and at least one of an FFP start location and an FFP length of a terminal, and the FFP start location of the network-side device is different from the FFP start location of the terminal.

An embodiment of the present disclosure further provides a computer-readable storage medium. A computer program is stored in the computer-readable storage medium. When the computer program is executed by a processor, the steps of the data transmission method for an unlicensed band that is applied to the network-side device are implemented, and a same technical effect can be achieved. To avoid repetition, details are not described herein.

A person of ordinary skill in the art may recognize that, with reference to the examples described in the embodiments disclosed herein, units and algorithm steps may be implemented by electronic hardware or a combination of computer software and electronic hardware. Whether these functions are implemented by using hardware or software depends on the specific application and design constraints of the technical solution. A person skilled in the art may use different methods for each particular application to implement the described functions, but such implementation shall not be considered to be outside the scope of the present disclosure.

It may be clearly understood by a person skilled in the art that, for convenience and brevity of description, for a specific working process of the foregoing described system, apparatus, and unit, reference may be made to a corresponding process in the foregoing method embodiments, and details are not described herein again.

In the embodiments provided in this application, it should be understood that the disclosed apparatus and method may be implemented in another manner. For example, the described apparatus embodiment is merely an example. For example, the unit division is merely logical function division. In actual implementation, there may be another division manner. For example, multiple units or components may be combined or integrated into another system, or some features may be ignored or not performed. In addition, the displayed or discussed mutual coupling or direct coupling or communication connection may be through some interfaces, indirect coupling or communication connection of the apparatus or unit, and may be in an electrical, mechanical, or another form.

The units described as separate parts may or may not be physically separate, and parts displayed as units may or may not be physical units, may be located in one place, or may be distributed on multiple network units. Some or all of the units may be selected based on an actual requirement to implement the objectives of the solutions in the embodiments.

In addition, functional units in the embodiments of the present disclosure may be integrated into one processing unit, or each unit may exist separately physically, or two or more units may be integrated into one unit.

The function may be stored in a computer readable storage medium if it is implemented in the form of a software functional unit and sold or used as an independent product. Based on such an understanding, the technical solutions of the present disclosure essentially or the part contributing to an existing technology or a part of the technical solutions may be implemented in a form of a software product. The computer software product is stored in a storage medium and includes several instructions for instructing a computer device (which may be a personal computer, a server, a network-side device, or the like) to perform all or some steps in the methods described in the embodiments of the present disclosure. The foregoing storage medium includes any medium that can store program code, such as a USB flash drive, a removable hard disk, a ROM, a RAM, a magnetic disk, or an optical disc.

A person of ordinary skill in the art may understand that all or some of the processes in the methods in the foregoing embodiments may be implemented by using a computer program to control related hardware. The program may be stored in a computer readable storage medium. When the program is executed, the processes in the foregoing methods embodiments may be performed. The storage medium includes a magnetic disk, a compact disc, a ROM, a RAM, or the like.

It may be understood that the embodiments described in the embodiments of the present disclosure may be implemented by hardware, software, firmware, middleware, microcode, or a combination thereof. For hardware implementation, a module, a unit, a subunit, or the like may be implemented in one or more ASICs, a Digital Signal Processing (DSP), a DSP Device (DSPD), a Programmable Logic Device (PLD), an FPGA, a general purpose processor, a controller, a microcontroller, a microprocessor, another electronic unit configured to perform the functions described in the present disclosure, or a combination thereof.

For software implementations, the techniques described in the embodiments of the present disclosure may be implemented by modules (for example, processes and functions) that perform the functions described in the embodiments of the present disclosure. The software code may be stored in a memory and executed by a processor. The memory may be implemented in or outside the processor.

It should also be noted that in the apparatus and method in the present disclosure, it is obvious that components or steps may be decomposed and/or recombined. The decomposition and/or recombination shall be considered as an equivalent solution of the present disclosure. In addition, the steps for performing the foregoing series of processing may naturally be performed in a described chronological order, but do not necessarily need to be performed in a chronological order. Some steps may be performed in parallel or independently. A person of ordinary skill in the art can understand that all or any of the steps or components of the method and apparatus in the present disclosure may be implemented in any computing apparatus (including a processor, a storage medium, and the like) or a network of the computing apparatus by using hardware, firmware, software, or a combination thereof, which can be implemented by a person of ordinary skill in the art by using a basic programming skill after reading descriptions of the present disclosure.

Therefore, the objective of the present disclosure may also be implemented by running a program or a set of programs on any computing apparatus. The computing apparatus may be a well-known general apparatus. Therefore, the objective of the present disclosure may also be implemented only by providing a program product including program code for implementing the method or apparatus. In other words, such a program product also constitutes the present disclosure, and a storage medium that stores such a program product also constitutes the present disclosure. Obviously, the storage medium may be any well-known storage medium or any storage medium developed in the future. It should also be noted that in the apparatus and method in the present disclosure, it is obvious that components or steps may be decomposed and/or recombined. The decomposition and/or recombination shall be considered as an equivalent solution of the present disclosure. In addition, the steps for performing the foregoing series of processing may naturally be performed in a described chronological order, but do not necessarily need to be performed in a chronological order. Some steps may be performed in parallel or independently.

The foregoing description is an optional implementation of the present disclosure. It should be noted that, for a person of ordinary skill in the art, improvements and ornaments may be made without departing from the principles of the present disclosure. The improvements and ornaments are also within the protection scope of the present disclosure.

1. A data transmission method for an unlicensed band, performed by a terminal, comprising:
performing uplink transmission based on Fixed Frame Period (FFP) configuration information and a channel state,
wherein:
the FFP configuration information comprises: at least one of an FFP start location or an FFP length of the terminal, and at least one of an FFP start location or an FFP length of a network-side device, and
the FFP start location of the terminal is different from the FFP start location of the network-side device.

2. The data transmission method for an unlicensed band according to claim 1, wherein
the FFP length of the terminal is different from the FFP length of the network-side device; or
the FFP length of the terminal is the same as the FFP length of the network-side device.

3. The data transmission method for an unlicensed band according to claim 1, wherein the FFP start location of the terminal is later than the FFP start location of the network-side device, and the performing uplink transmission based on FFP configuration information and a channel state comprises:
performing at least one of the following operations in an FFP idle time period indicated by the FFP configuration information: Clear Channel Assess (CCA) to obtain the channel state, downlink signal detection to obtain a detection result, or downlink channel detection to obtain a detection result; and
determining, based on at least one of the channel state or the detection result, whether to perform uplink transmission.

4. The data transmission method for an unlicensed band according to claim 3, wherein the determining, based on the channel state, whether to perform uplink transmission comprises any one of the following:
when the terminal detects a downlink signal or a downlink channel and detects that the channel is idle, performing uplink transmission;
when the terminal detects a downlink signal or a downlink channel and detects that the channel is busy, skipping performing uplink transmission;
when the terminal does not detect a downlink signal or a downlink channel and detects that the channel is idle, performing uplink transmission; or
when the terminal does not detect a downlink signal or a downlink channel and detects that the channel is busy, skipping performing uplink transmission.

5. The data transmission method for an unlicensed band according to claim 4, wherein the performing uplink transmission comprises either of the following:
sharing, by the terminal, Channel Occupancy Time (COT) of the network-side device to perform uplink transmission, wherein transmission duration does not exceed the COT of the network-side device; or
initiating, by the terminal, COT to perform uplink transmission.

6. The data transmission method for an unlicensed band according to claim 4, wherein the uplink transmission is Physical Random Access Channel (PRACH) transmission, and the performing uplink transmission comprises either of the following:
when the terminal detects a downlink signal or a downlink channel and detects that the channel is idle, selecting, by the terminal, any Random Access Channel (RACH) occasion in an FFP of the terminal to perform PRACH transmission, wherein transmission duration does not exceed COT of the network-side device; or
when the terminal does not detect a downlink signal or a downlink channel and detects that the channel is idle, performing, by the terminal, PRACH transmission at a first RACH occasion in an FFP of the terminal.

7. The data transmission method for an unlicensed band according to claim 5, wherein the initiating, by the terminal, COT to perform uplink transmission comprises either of the following:
receiving first indication information of the network-side device, wherein the first indication information indicates that the terminal is allowed to initiate COT to perform uplink transmission; or
determining, by the terminal, whether to initiate COT.

8. The data transmission method for an unlicensed band according to claim 5, wherein after the sharing, by the terminal, COT of the network-side device to perform uplink transmission, the method further comprises:
receiving second indication information of the network-side device, wherein the second indication information indicates that the terminal is allowed to share the COT of the network-side device.

9. The data transmission method for an unlicensed band according to claim 1, wherein the FFP start location of the terminal is earlier than the FFP start location of the network-side device, and the method further comprises:
sending third indication information to the network-side device, wherein the third indication information indicates that the network-side device is allowed to share the COT of the terminal.

10. The data transmission method for an unlicensed band according to claim 1, wherein the FFP start location is an absolute time domain location or an offset value relative to a reference location.

11. The data transmission method for an unlicensed band according to claim 3, wherein uplink transmission resources in the first X symbols of the FFP of the terminal are invalid, and X is an integer greater than or equal to 1.

12. A data transmission method for an unlicensed band, performed by a network-side device, comprising:
performing downlink transmission based on Fixed Frame Period (FFP) configuration information and a channel state,
wherein:
the FFP configuration information comprises at least one of an FFP start location or an FFP length of the network-side device, and at least one of an FFP start location or an FFP length of a terminal, and
the FFP start location of the network-side device is different from the FFP start location of the terminal.

13. The data transmission method for an unlicensed band according to claim 12, wherein:
the FFP length of the terminal is different from the FFP length of the network-side device; or
the FFP length of the terminal is the same as the FFP length of the network-side device.

14. The data transmission method for an unlicensed band according to claim 12, wherein the FFP start location of the network-side device is later than the FFP start location of the terminal, and the performing downlink transmission based on FFP configuration information and a channel state comprises:
performing at least one of the following operations in an FFP idle time period indicated by the FFP configuration information:
Clear Channel Assess (CCA) to obtain the channel state,
uplink signal detection to obtain a detection result, or
uplink channel detection to obtain a detection result; and
determining, based on at least one of the channel state and the detection result, whether to perform downlink transmission.

15. The data transmission method for an unlicensed band according to claim 14, wherein the determining, based on the channel state, whether to perform downlink transmission comprises any one of the following:
when the network-side device detects an uplink signal or an uplink channel and detects that the channel is idle, performing downlink transmission;
when the network-side device detects an uplink signal or an uplink channel and detects that the channel is busy, skipping performing downlink transmission;
when the network-side device does not detect an uplink signal or an uplink channel and detects that the channel is idle, performing downlink transmission; or
when the network-side device does not detect an uplink signal or an uplink channel and detects that the channel is busy, skipping performing downlink transmission.

16. The data transmission method for an unlicensed band according to claim 15, wherein the performing downlink transmission comprises either of the following:
sharing, by the network-side device, Channel Occupancy Time (COT) of the terminal to perform downlink transmission, wherein transmission duration does not exceed the COT of the terminal; and
initiating, by the network-side device, COT to perform downlink transmission.

17. The data transmission method for an unlicensed band according to claim 12, wherein the FFP start location of the terminal is later than the FFP start location of the network-side device, and the method further comprises:
sending second indication information to the terminal, wherein the second indication information indicates that the terminal is allowed to share COT of the network-side device.

18. The data transmission method for an unlicensed band according to claim 12, further comprising:
sending first indication information to the terminal, wherein the first indication information indicates that the terminal is allowed to initiate COT to perform uplink transmission.

19. A communication device, comprising: a memory, a processor, and a computer program that is stored in the memory and that can run on the processor, wherein when the processor executes the computer program, following steps are implemented:
performing uplink transmission based on Fixed Frame Period (FFP) configuration information and a channel state,
wherein:
the FFP configuration information comprises: at least one of an FFP start location or an FFP length of the terminal, and at least one of an FFP start location or an FFP length of a network-side device, and
the FFP start location of the terminal is different from the FFP start location of the network-side device.

20. A communication device, comprising: a memory, a processor, and a computer program that is stored in the memory and that can run on the processor, wherein the computer program, when executed by the processor, causes the processor to perform the data transmission method for an unlicensed band according to claim 12.
